(19) United States
(12) Patent Application Publication
(10) Pub. No.: US 2008/0082406 A1
(43) Pub. Date: Apr. 3, 2008

(54) TREATMENT OF EPISODIC GAMES RESPONSIVE TO USER GAME PLAYING ACTIVITY

(76) Inventors: Michael Dale Lampell, Novato, CA (US); Stanley C. Ng, Los Altos, CA (US)

Correspondence Address: BEYER WEAVER LLP/APPLE INC., P.O. BOX 70250, OAKLAND, CA, 94612-0250, US

(21) Appl. No.: 11/530,765

(22) Filed: Sep. 11, 2006

(51) Int. Cl. G06Q 30/00; A63F 13/00

(52) U.S. Cl. 705/14; 463/31

(57) ABSTRACT

Information about how users have interacted with current and/or previous game episodes may be used to determine how to treat (e.g., in the process of marketing) subsequent game episodes. Information regarding a particular game player's behavior with respect to playing a particular episode of a game may be generated, and the behavior information may be provided to a game episode commerce service. Based on the provided behavior information, the game episode commerce service may generate commerce information regarding at least one subsequent episode of the game. The commerce information may be processed with respect to the at least one subsequent episode.

### BACKGROUND

The present invention relates to digital game assets and, more particularly, to treatment (such as marketing) of episodic digital game assets from an on-line media store responsive to user game playing activity.

Portable media players and other portable devices may provide, as either a primary function or a secondary function, the capability to play games. Such games may be provided in either a single or episodic fashion. Games being provided in an “episodic” fashion means that the games are provided as a series of episodes. Each episode is an independent game, but the series of episodes are related in some way.

### SUMMARY

A method in accordance with an aspect of the invention may use information about how users have interacted with current and/or previous game episodes in the process of marketing subsequent game episodes. Information regarding a particular game player's behavior with respect to playing a particular episode of a game may be generated, and the behavior information may be provided to a game episode commerce service. Based on the provided behavior information, the game episode commerce service may generate commerce information regarding at least one subsequent episode of the game. The commerce information may be processed with respect to the at least one subsequent episode.

For example, the generated commerce information may include an indication of an offer to purchase the at least one subsequent episode, and processing the commerce information with respect to the at least one subsequent episode includes completing the purchase of the at least one subsequent episode. As another example, the generated commerce information may include an indication of an enablement of use of the at least one subsequent episode by the particular game player, who has previously conducted commerce to pre-pay for the use of the at least one subsequent episode, and processing the commerce information includes enabling the use of the at least one subsequent episode by the particular game player. As yet another example, the generated commerce information may include an indication of customization of the at least one subsequent episode for the particular game player, and processing the commerce information such that the at least one subsequent episode is customized.

Other aspects and advantages will become apparent from the following detailed description taken in conjunction with the accompanying exemplary drawings.

### BRIEF DESCRIPTION OF THE DRAWINGS

The invention will be readily understood by the following detailed description in conjunction with the accompanying drawings, wherein like reference numerals designate like structural elements, and in which:

FIG. 1 is an architectural block diagram of an exemplary media purchase system via which a player's behavior with respect to a current game episode may affect the marketing of at least one subsequent game episode.

FIG. 2 is a block diagram that illustrates an example of data flow through the FIG. 1 system to accomplish marketing of the at least one subsequent game episode.

FIG. 3 is a flowchart illustrating an example of processing to accomplish the marketing of the at least one subsequent game episode.

### DETAILED DESCRIPTION

The inventors have realized that, while providing games in an episodic fashion can be an effective marketing tool (i.e., a player of an episode of a game is likely to be interested in other episodes of the same game), it can be even more effective to market or otherwise treat subsequent game episodes to users based on information about how the users have interacted with current and/or previous game episodes.

We first describe an example system architecture in which such treatment of subsequent game episodes may be implemented. We then describe particular examples of such treatment of subsequent game episodes.

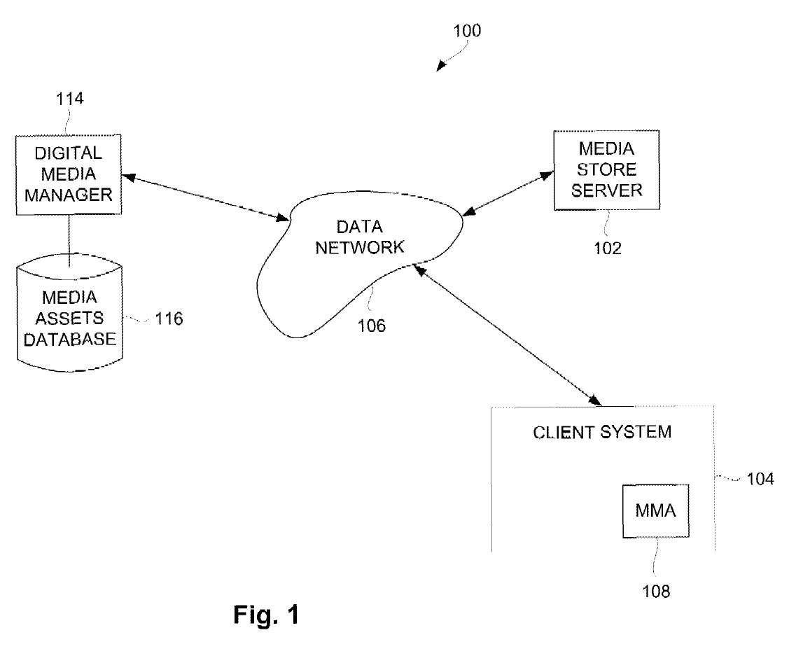

FIG. 1 is an architectural block diagram of an exemplary media purchase system 100, in which treatment (such as marketing) of episodic games to users may be based on information about how the users have interacted with current and/or previous game episodes. The media purchase system 100 may include a media store server 102 that may host an on-line media store. The media store server 102 can off-load commerce transactions and/or delivery of purchased digital media assets, such as games, to other servers, if desired. As shown in FIG. 1, the media purchase system 100 may include one or more client systems 104 for use by end users. The client system 104 may couple to a data network 106. Additionally, the media store server 102 may also couple to the data network 106. In one implementation, the data network 106 can refer to one or more data networks, typically, high data-bandwidth networks, namely, wired networks, such as the Internet, Ethernet, gigabit Ethernet, and fiber optic, as well as wireless networks such as IEEE 802.11(a),(b) or (g) (WiFi), IEEE 802.16 (WiMax), and Ultra-Wide Band (UWB).

A computer program 108, typically a media management application (MMA) or other media player application, may run on the client system 104. One example of a media management application is the iTunes® application, produced by Apple Computer, Inc. of Cupertino, Calif. The client system 104 may include, in general, computing devices. As an example, the client system 104 can include specific or general-purpose personal computers and/or portable media players. One example of such a portable media player is the iPod®, also produced by Apple Computer, Inc. The computer program 108 can be used by a consumer for a variety of purposes, including, but not limited to: (i) browsing, pre-ordering and/or purchasing media assets from the on-line media store provided by the media store server 102, (ii) creating and sharing media asset groups (e.g., playlists), (iii) organizing media assets, (iv) presenting/playing media assets, and (v) transferring media assets between client systems 104.

The media purchase system 100 may also include a digital asset manager 114. The digital asset manager 114 is coupled to a media assets database 116. The media assets database 116 stores media asset information including metadata relating to digital media assets available for purchase or pre-order at the on-line media store. In one embodiment, the digital asset manager 114 can control what media assets and media asset information are available on the on-line media store. The metadata can pertain to individual media assets (digital media assets) or media asset groups (digital media asset groups). Media assets can include, but are not limited to games, music, video, text and/or graphics files.

The media store server 102 can enable the user of a particular client system 104 to purchase or pre-order media assets through on-line transactions. On-line transactions to purchase media items are also referred to as electronic commerce (e-commerce). Subsequently, the client system 104 can cause the purchased media assets to be downloaded from the media store server 102, or some other server, via the data network 106. As will be understood by those familiar with data networks, other network configurations are possible. Furthermore, while the media store server 102 and the digital asset manager 114 are shown as individual and separate devices, it will be understood by those familiar with the art that other configurations are possible. As one example, each device can be implemented such that it is distributed over multiple server computers. As another example, these various servers and/or managers can be implemented by a single physical server computer.

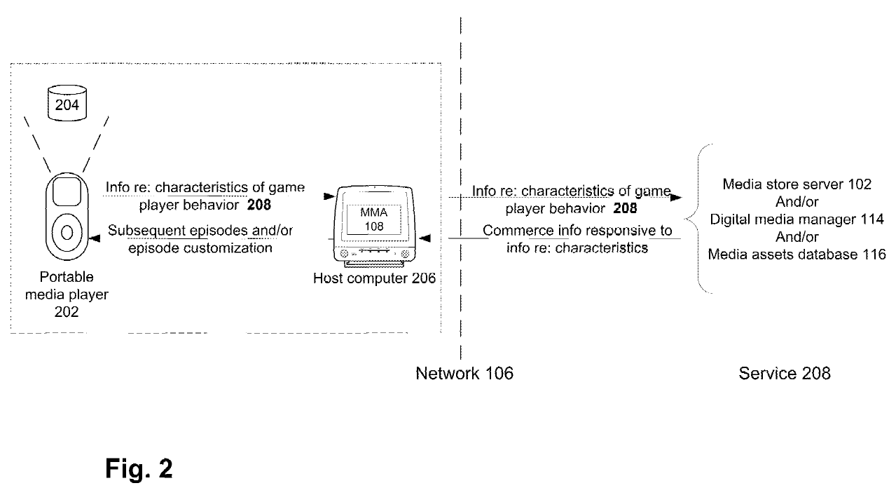

As mentioned above, the client system 104 can include facility for a user to play games. The client system 104 can also include facility to monitor characteristics of a game player's behavior with respect to particular game episodes. As will be discussed with reference to FIG. 2, the monitored behavior characteristics may be provided from the client system 104 to the media store provider 102 and/or to the digital media manager 114 and used in the treatment (such as marketing) of subsequent game episodes to users with respect to the player.

Referring now to FIG. 2, the illustrated client system 104 may include a portable media player 202 that includes local storage 204. The client system 104 may also include a general purpose computer 206 that executes the Media Management Application (MMA) 108. The portable media player 202 may include functionality to allow a user to interact with a user interface of the portable media player 202 to play a game episode that has been downloaded or otherwise made accessible to the portable media player 202.

As the game episode is being played, the game player's behavior with respect to the game and/or with respect to other functions of the portable media player 202 may be monitored. In one example, indications of the game player's monitored behavior may be stored in a storage mechanism 204 associated with the portable media player 202, typically (but not required to be) physically contained within a housing of the portable media player 202.

Generally speaking, the player behavior indications may be provided via the network 106 to a game episode service 208 that includes processing to process the player behavior indications, to generate commerce information that is responsive to the player behavior indications. The term “service” is meant to broadly indicate a functionality and does not necessarily indicate any particular configuration of one or more computers. In one example, the game episode commerce service 208 is provided by one or more of the media store server 102, the digital media manager 114 or the media assets database 116 in association with, in conjunction with, or as part of, other functionality of those components.

In a specific example, the player behavior indications may be provided from the portable media player 202 to the host computer 206 when the portable media player 202 is connected to the host computer 206 to interoperate with the MMA 108, as part of an exchange of data that happens normally between the portable media player 202 and the MMA 108 when the portable media player 202 and the MMA 108 are connected. The player behavior indications may then be provided to the game episode commerce service 208. In some examples, the host computer 206 acts substantially as a conduit for providing the player behavior indications.

In other examples, the player behavior indications may be provided from the portable media player 202 to the game episode commerce service 208 without being provided to a host computer such as the host computer 204. For example, the portable media player 202 may be directly connectable to the game episode commerce service 208. In one example, the portable media player 202 may be incorporated into or, may be incorporated with, a telephone or other communication device that is connectable (e.g., wirelessly) to the game episode commerce service 208.

Based on processing the player behavior indications, commerce information may be provided to the MMA 108 and/or to the portable media player 202. For example, based on an indication that a player has reached a particular level with respect to a particular game episode, the commerce information may include information to cause a subsequent game episode to be offered to the player. The commerce information may include information to cause customization of a subsequent game episode for the player, such as taking a particular path through the game episode or offering particular features of the game episode, based on how the previous game episode or game episodes were played.

In one example, the player may have pre-purchased a particular number of episodes (e.g., even before the episodes are accessible) or may have purchased an ability to access episodes for a particular amount of time, and the commerce information may include information that can be used to unlock or otherwise enable a subsequent game episode to be accessed (e.g., downloaded) and/or played. Pre-ordering may be accomplished, for example, in a manner similar to that described in U.S. patent application Ser. No. 11/247,948, entitled “On-Line Media Store that Supports Pre-Ordering of Digital Media Assets”, and filed on Oct. 10, 2005 (hereby incorporated by reference in its entirety). The unlocking or otherwise enabling may be a result of explicit interaction between the player and the portable media player 202 and/or MMA 108 or may be a result of substantially automatic processing.

The commerce information may cause commerce-related notifications and/or suggestions to be provided to the player, relative to the game episodes. For example, the commerce information may cause a notification to be provided to the player indicating that the player is able to and/or should access another game episode. The commerce information may cause a notification that various paths are available through a particular episode.

In one example, the commerce information is provided to the MMA 108, operating on the host computer, and the MMA 108 may interoperate with the portable media player 202 based at least in part on the commerce information. For example, the interoperation of the MMA 108 and the portable media player 202 with respect to the commerce information may be integrated into the overall interoperation of the MMA 108 and the portable media player 202. In another example, the portable media player 202 interoperates more directly over the network with a service or services to obtain the commerce information and to act upon the commerce information.

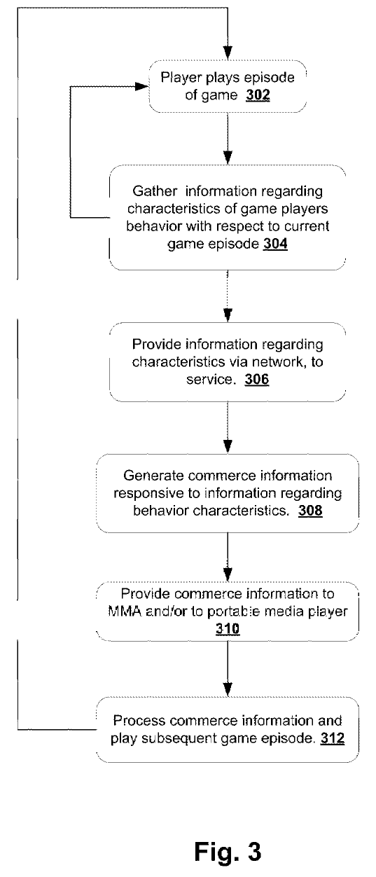

FIG. 3 is a flowchart illustrating an example of the processing discussed above. Step 302 includes a player playing an episode of a game. At step 304 (typically, in conjunction with step 302), information may be gathered regarding characteristics of the game player's behavior with respect to the game episode. For example, the information may be stored in local portable media player storage 204. At step 306, the information regarding the player behavior characteristics may be provided, via the network, to the game episode commerce service 208.

At step 308, commerce information may be generated that is responsive to the information regarding the player behavior characteristics. At step 310, the commerce information may be provided to the MMA and/or to the portable media player. At step 312, the commerce information may be appropriately processed and the player may be able to play subsequent game episodes.

Thus, methods and systems have been shown to market or otherwise treat subsequent game episodes to users based on information about how the users have interacted with current and/or previous game episodes. As discussed, for example, this can be a very effective marketing tool.

The following application is hereby incorporated by reference in its entirety: U.S. patent application Ser. No. 11/481,303, filed Jul. 3, 2006, and entitled “MEDIA MANAGEMENT SYSTEM FOR MANAGEMENT OF GAMES ACQUIRED FROM A MEDIA SERVER.”

What is claimed is:

1. An episodic game commerce method, comprising:
generating information regarding a particular game player's behavior with respect to playing a particular episode of a game;
providing the behavior information to a game episode commerce service;
based on the provided behavior information, by the game episode commerce service, generating commerce information regarding at least one subsequent episode of the game; and
processing the commerce information with respect to the at least one subsequent episode.

2. The method of claim 1, wherein:
the generated commerce information includes an indication of an offer to purchase the at least one subsequent episode; and
processing the commerce information with respect to the at least one subsequent episode includes completing the purchase of the at least one subsequent episode.

3. The method of claim 1, wherein:
the generated commerce information includes an indication of an enablement of use of the at least one subsequent episode by the particular game player, who has previously conducted commerce to pre-pay for the use of the at least one subsequent episode; and
processing the commerce information includes enabling the use of the at least one subsequent episode by the particular game player.

4. The method of claim 1, wherein:
the generated commerce information includes an indication of customization of the at least one subsequent episode for the particular game player; and
processing the commerce information such that the at least one subsequent episode is customized.

5. The method of claim 1, wherein:
during play of the particular episode by the particular game player, the generated behavior information is stored in memory of a portable media player on which the particular episode is being played;
providing the behavior information to a game episode commerce service includes providing the behavior information from the memory of the portable media player.

6. The method of claim 1, wherein:
during play of the particular episode by the particular game player, the generated behavior information is stored in memory of a portable media player on which the particular episode is being played; and
providing the behavior information to a game episode commerce service includes providing the behavior information from the memory of the portable media player to the game episode commerce service via a media management application interoperating with the portable media player.

7. The method of claim 6, further comprising:
coupling the portable media player for communication with a host computer executing the media management application to facilitate the interoperation of the media management application with the portable media player.

8. The method of claim 1, wherein:
processing the commerce information with respect to the at least one subsequent episode includes a media management application facilitating commerce with the particular game player, with respect to the at least one subsequent episode, based at least in part on interaction between the particular game player and the media management application.

9. A method of operating a digital media commerce service to facilitate commerce with respect to digital episodic game media, the method comprising:
receiving information regarding a game player's behavior with respect to playing a particular episode of a game;
based on the received behavior information, generating commerce information regarding at least one subsequent episode of the game;
and, conducting commerce with the player with respect to the at least one subsequent episode, based at least in part on the generated commerce information.

10. A method of operating a system, including a portable media player, with respect to an episodic game, comprising:
operating the portable media player in cooperation with a game player to accomplish play of a particular episode of a game;
providing behavior information, of the player with respect to playing the particular game episode, to a game episode commerce service; and
receiving commerce information from the game episode commerce service with respect to at least one subsequent episode of the game and processing the received commerce information with respect to the at least one subsequent episode.

11. The method of claim 10, wherein:
the received commerce information includes an indication of an offer to purchase the at least one subsequent episode; and
processing the received commerce information with respect to the at least one subsequent episode includes operating a media management application in cooperation with the game episode commerce service to complete the purchase of the at least one subsequent episode.

12. The method of claim 10, wherein:
the received commerce information includes an indication of an enablement of use of the at least one subsequent episode by the particular game player, who has previously conducted commerce to pre-pay for the use of the at least one subsequent episode; and
processing the received commerce information includes operating a media management application in cooperation with the game episode commerce service to enable the use of the at least one subsequent episode by the particular game player.

13. The method of claim 10, wherein:
the received commerce information includes an indication of customization of the at least one subsequent episode for the particular game player; and
processing the received commerce information includes customizing the at least one subsequent episode based on the generated commerce information.

14. The method of claim 10, wherein:
during play of the particular episode by the particular game player, the generated behavior information is stored in memory of the portable media player on which the particular episode is being played;
providing the behavior information to a game episode commerce service includes providing the behavior information from the memory of the portable media player.

15. The method of claim 10, wherein:
during play of the particular episode by the particular game player, the generated behavior information is stored in memory of the portable media player on which the particular episode is being played; and
providing the behavior information to a game episode commerce service includes providing the behavior information from the memory of the portable media player to the game episode commerce service via a media management application interoperating with the portable media player.

16. The method of claim 15, further comprising:
coupling the portable media player for communication with a host computer executing the media management application to facilitate the interoperation of the media management application with the portable media player.

17. The method of claim 10, wherein:
processing the commerce information with respect to the at least one subsequent episode includes a media management application facilitating commerce with the particular game player, with respect to the at least one subsequent episode, based at least in part on interaction between the particular game player and the media management application.

18. A computer program product to operate an electronic device with respect to an episodic game, the computer program product comprising at least one computer-readable medium having computer program instructions stored therein which are operable to cause at least one computing device of the electronic device to:
operate the electronic device in cooperation with a game player to accomplish play of a particular episode of the game;
provide behavior information, of the player with respect to playing the particular game episode, to a game episode commerce service; and
receive commerce information from the game episode commerce service with respect to at least one subsequent episode of the game and process the received commerce information with respect to the at least one subsequent episode.

19. The computer program product of claim 18, wherein:
the received commerce information includes an indication of an offer to purchase the at least one subsequent episode; and
the computer program instructions which are operable to cause the at least one computing device to process the received commerce information with respect to the at least one subsequent episode includes compute program instructions to cause the at least one computing device to operate a media management application in cooperation with the game episode commerce service to complete the purchase of the at least one subsequent episode.

20. The computer program product of claim 18, wherein:
the received commerce information includes an indication of an enablement of use of the at least one subsequent episode by the particular game player, who has previously conducted commerce to pre-pay for the use of the at least one subsequent episode; and
the computer program instructions which are operable to cause the at least one computing device to process the received commerce information includes compute program instructions to cause the at least one computing device to operate a media management application in cooperation with the game episode commerce service to enable the use of the at least one subsequent episode by the particular game player.

21. The computer program product of claim 18, wherein:
the received commerce information includes an indication of customization of the at least one subsequent episode for the particular game player; and
the computer program instructions which are operable to cause the at least one computing device to process the received commerce information includes the computer program instructions which are operable to cause the at least one computing device to customize the at least one subsequent episode based on the generated commerce information.

22. The computer program product of claim 18, wherein:
during play of the particular episode by the particular game player, the generated behavior information is stored in memory of the portable media player on which the particular episode is being played;
the computer program instructions which are operable to cause the at least one computing device to provide the behavior information to a game episode commerce service includes the computer program instructions which are operable to cause the at least one computing device to provide the behavior information from the memory of the portable media player.

23. The computer program product of claim 18, wherein:
during play of the particular episode by the particular game player, the generated behavior information is stored in memory of the portable media player on which the particular episode is being played; and
the computer program instructions which are operable to cause the at least one computing device to provide the behavior information to a game episode commerce service includes the computer program instructions which are operable to cause the at least one computing device to provide the behavior information from the memory of the portable media player to the game episode commerce service via a media management application interoperating with the portable media player.

24. The computer program product of claim 23, further comprising:
computer program instructions which are operable to cause the at least one computing device to couple the portable media player for communication with a host computer executing the media management application to facilitate the interoperation of the media management application with the portable media player.

25. The computer program product of claim 18, wherein:
computer program instructions which are operable to cause the at least one computing device to process the commerce information with respect to the at least one subsequent episode includes computer program instructions which are operable to cause the at least one computing device to execute a media management application facilitating commerce with the particular game player, with respect to the at least one subsequent episode, based at least in part on interaction between the particular game player and the media management application.
